(19) United States
(12) Patent Application Publication
(10) Pub. No.: US 2018/0117957 A1
(43) Pub. Date: May 3, 2018

(54) Paul's Paint Screen Wringer

(71) Applicant: Paul C. Nogle, Peyton, CO (US)

(72) Inventor: Paul C. Nogle, Peyton, CO (US)

(21) Appl. No.: 15/787,221

(22) Filed: Oct. 18, 2017

(51) Int. Cl. B44D 3/12

(52) U.S. Cl. CPC B44D 3/128

(57) ABSTRACT

This Present invention may be used for cleaning a five gallon paint screen of all the useable paint, leaving the restricting particles in the screen, and the clean paint ready for use, in an airless paint spryer or any other applicator of use in painting. Placing the paint screen between the cleaning blades, then bringing the cleaning blades together with hand pressure from the handles in one hand, the other hand is pulling the paint screen upward through the cleaning blades tell the end of the screen is reached, and all the clean paint is recovered.

### BACKGROUND OF INVENTION

This invention is a means of recovering useable paint through the paint screening process. This tool is used in conjunction with a five gallon, fine mess paint screen. The tool generates a clamping action via two opposing blades hinged at one end with a continuous molded plastic from the hinge to the blades to the handles. With the two handles pressure is applied to the blades as the fine mesh paint screen is pulled upward through the blades, creating a wringing action removing the clean paint from the screen, leaving the debris in the paint screen.

### SUMMARY OF INVENTION

This tool is a means of recovering clean paint from dirty paint, quickly, cleanly and efficiently. The opposing blades are hinged at one end with a flexible plastic continuous to the blades, to the handles, making the tool one piece plastic; the flexible hinge allows the user to apply a clamping action with one hand and with the other hand a paint screen is pulled in opposite direction, creating a wringing action removing the useable paint.

### DETAILED DESCRIPTION

The following details description represents the best to date contemplated method of carrying out the process of removing clean paint from the paint screening process. This discerption is not to be taken in a limiting sense, but is merely for the purpose of illustrating the general principles of this invention.

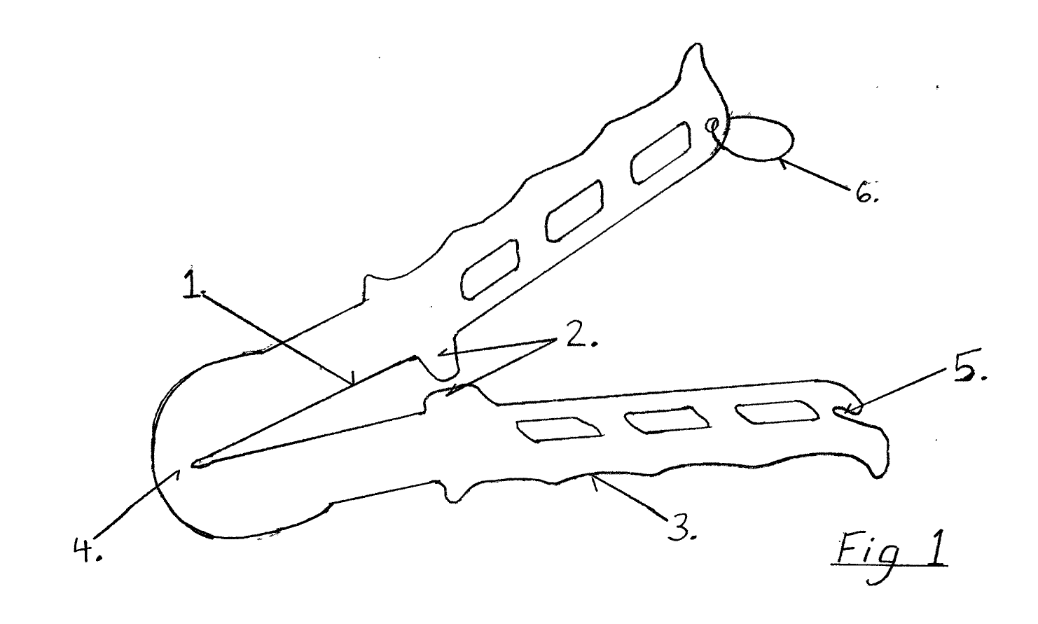

FIG. 1. Illustrates the complete wringer tool;

Referring to FIG. 1.
1. Is the cleaning blade surface
2. Is the stop to keep the screen in the blade area while cleaning
3. The handle for putting pressure on the cleaning blades
4. The hinge pivot for the cleaning blades
5. A notch to receive the elastic band
6. Elastic band placed in the notch to keep the tool closed while not in use

1. A means of extracting the clean paint from a five gallon paint screen.

2. The two blades of the wringer make it possible to extract the clean paint without touching the paint screen with your hand.

3. The wringer action speeds up the screening processes.
